(19) United States
(12) Patent Application Publication
(10) Pub. No.: US 2023/0354461 A1
(43) Pub. Date: Nov. 2, 2023

(54) METHODS AND APPARATUSES FOR CONTROLLING CONNECTION STATE OF TERMINAL DEVICE

(71) Applicant: Telefonaktiebolaget LM Ericsson (publ), Stockholm (SE)

(72) Inventors: Zhang ZHANG, Beijing (CN); Zhang FU, Stockholm (SE); Congchi ZHANG, Shanghai (CN); Juying GAN, Shanghai (CN)

(73) Assignee: Telefonaktiebolaget LM Ericsson (publ), Stockholm (SE)

(21) Appl. No.: 17/999,710

(22) PCT Filed: May 24, 2021
(86) PCT No.: PCT/CN2021/095521

§ 371 Date: Nov. 23, 2022

(30) Foreign Application Priority Data
May 26, 2020 (WO) PCTCN2020092375

(51) Int. Cl. H04W 76/27; H04W 76/34

(52) U.S. Cl. CPC H04W 76/27; H04W 76/34; H04W 88/04

(57) ABSTRACT

Methods and apparatuses for controlling connection state of a terminal device. A user plane of a base station determines whether a first terminal device that acts as a terminal device to network relay for one or more second terminal devices in radio resource control (RRC) connected state is inactive, based on traffic conditions of the first terminal device and the one or more second terminal devices. The user plane reports a result of the determination to a control plane of the base station.

### TECHNICAL FIELD

Embodiments of the disclosure generally relate to communication, and, more particularly, to methods and apparatuses for controlling connection state of terminal device.

### BACKGROUND

This section introduces aspects that may facilitate better understanding of the present disclosure. Accordingly, the statements of this section are to be read in this light and are not to be understood as admissions about what is in the prior art or what is not in the prior art.

The 3rd generation partnership project (3GPP) specified long term evolution (LTE) device-to-device (D2D) technology, also known as proximity services (ProSe) in Release (Rel.) 12 and 13 of LTE. Later in Rel. 14 and 15, LTE vehicle-to-everything (V2X) related enhancements targeting the specific characteristics of vehicular communications were specified. In Rel. 16, the 3GPP has a work item (WI) to develop a new radio (NR) version of V2X communications. The NR V2X mainly targets advanced V2X services, which can be categorized into four use case groups: vehicles platooning, extended sensors, advanced driving and remote driving. The advanced V2X services would require enhanced NR system and new NR sidelink framework to meet the stringent requirements in terms of latency and reliability. NR V2X system also expects to have higher system capacity and better coverage and to allow for an easy extension to support the future development of further advanced V2X services and other services such as public safety (PS) services.

Given the targeted services by NR V2X, it is commonly recognized that groupcast/multicast and unicast transmissions are desired, in which the intended receiver of a message consists of only a subset of the vehicles in proximity to the transmitter (groupcast) or of a single vehicle (unicast). For example, in the platooning service there are certain messages that are only of interest to the members of the platoon, making the members of the platoon a natural groupcast. In another example, the see-through use case most likely involves only a pair of vehicles, for which unicast transmissions naturally fit. Therefore, NR sidelink can support broadcast (as in LTE), groupcast and unicast transmissions. Furthermore, NR sidelink is designed in such a way that its operation is possible with and without network coverage and with varying degrees of interaction between user equipments (UEs) and the network (NW), including support for standalone, network-less operation.

In Rel. 17 of the 3GPP, discussions are being taken place and national security and public safety (NSPS) is considered to be one important use case, which can benefit from the already developed NR sidelink features in Rel. 16. It is most likely that the 3GPP will specify enhancements related to NSPS use case taking NR Rel. 16 sidelink as a baseline. Besides, in some scenarios NSPS services need to operate with partial or without NW coverage, such as indoor firefighting, forest firefighting, earthquake rescue, sea rescue, etc. where the infrastructure is (partially) destroyed or not available. Therefore, coverage extension is a crucial enabler for NSPS, for both NSPS services communicated between UE and cellular NW and that communicated between UEs over sidelink.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for controlling connection state of terminal device. In particular, one of the problems to be solved by the disclosure is to avoid a terminal device to network relay from being improperly transferred to radio resource control (RRC) non-connected state.

According to a first aspect of the disclosure, there is provided a method performed by a base station. The method comprises determining, by a user plane of the base station, whether a first terminal device that acts as a terminal device to network relay for one or more second terminal devices in RRC connected state is inactive, based on traffic conditions of the first terminal device and the one or more second terminal devices. The method further comprises reporting, by the user plane, a result of the determination to a control plane of the base station.

In this way, it can be avoided that the first terminal device enters RRC non-connected state while the one or more second terminal devices are still in RRC connected state.

In an embodiment of the disclosure, determining whether the first terminal device is inactive may comprise performing terminal device level inactivity monitoring for the first terminal device.

In an embodiment of the disclosure, when there is no traffic received from and/or sent to the first terminal device and the one or more second terminal devices during a time period given by an inactivity timer, the first terminal device may be determined as inactive.

In an embodiment of the disclosure, the method may further comprise performing, by the user plane, data radio bearer (DRB) and/or protocol data unit (PDU) session level inactivity monitoring for the first terminal device.

In an embodiment of the disclosure, the method may further comprise receiving, by the user plane from the control plane, a first request for bearer context setup for the first terminal device. The first request may indicate a condition under which terminal device level inactivity monitoring should be performed. The terminal device level inactivity monitoring may be performed in response to the first terminal device satisfying the indicated condition.

In an embodiment of the disclosure, reporting the result of the determination to the control plane may comprise indicating at least a terminal device level inactivity status for the first terminal device.

In an embodiment of the disclosure, the method may further comprise receiving, by the user plane from the control plane, one or more second requests for bearer context modification.

In an embodiment of the disclosure, the one second request may comprise RRC suspend indications and terminal device identifiers (IDs) for the first terminal device and the one or more second terminal devices.

In an embodiment of the disclosure, the one second request may comprise an RRC suspend indication for the first terminal device, but comprise no RRC suspend indications for the one or more second terminal devices. The one or more second terminal devices may be determined to enter RRC non-connected state, based on the RRC suspend indication for the first terminal device.

In an embodiment of the disclosure, the more than one second requests may be used for the first terminal device and the one or more second terminal devices respectively.

In an embodiment of the disclosure, the RRC non-connected state may be RRC inactive state or RRC idle state.

According to a second aspect of the disclosure, there is provided a method performed by a base station. The method comprises receiving, by a control plane of the base station from a user plane of the base station, information related to traffic conditions of one or more second terminal devices in RRC connected state and a first terminal device that acts as a terminal device to network relay for the one or more second terminal devices. The method further comprises determining, by the control plane, whether the first terminal device should enter RRC non-connected state based on the received information.

In an embodiment of the disclosure, the information related to the traffic conditions of the one or more second terminal devices and the first terminal device may be a terminal device level inactivity status indicated for the first terminal device. The first terminal device may be determined to enter RRC non-connected state according to the terminal device level inactivity status indicated for the first terminal device.

In an embodiment of the disclosure, the method may further comprise determining, by the control plane, the one or more second terminal devices to enter RRC non-connected state according to the terminal device level inactivity status indicated for the first terminal device.

In an embodiment of the disclosure, the method may further comprise sending, by the control plane to the user plane, a first request for bearer context setup for the first terminal device. The first request may indicate a condition under which terminal device level inactivity monitoring should be performed.

In an embodiment of the disclosure, the information related to the traffic conditions of the one or more second terminal devices and the first terminal device may comprise one or more of: a result of terminal device level inactivity monitoring performed independently for the first terminal device and the one or more second terminal devices; a result of DRB level inactivity monitoring performed for DRBs related to the first terminal device and the one or more second terminal devices; and a result of PDU session level inactivity monitoring performed for PDU sessions related to the first terminal device and the one or more second terminal devices.

In an embodiment of the disclosure, the first terminal device may be determined to enter RRC non-connected state when one or more of the following conditions are satisfied: the result of the terminal device level inactivity monitoring indicates that the first terminal device and the one or more second terminal devices are inactive; the result of the DRB level inactivity monitoring indicates that the DRBs related to the first terminal device and the one or more second terminal devices are inactive; and the result of the PDU session level inactivity monitoring indicates that the PDU sessions related to the first terminal device and the one or more second terminal devices are inactive.

In an embodiment of the disclosure, the first terminal device may be determined not to enter RRC non-connected state when at least one of the one or more second terminal devices is determined to be kept in RRC connected state.

In an embodiment of the disclosure, the method may further comprise, when determining that the first terminal device should enter RRC non-connected state, sending, by the control plane to the user plane, one or more second requests for bearer context modification.

In an embodiment of the disclosure, the one second request may comprise RRC suspend indications and terminal device IDs for the first terminal device and the one or more second terminal devices.

In an embodiment of the disclosure, the one second request may comprise an RRC suspend indication for the first terminal device, but comprise no RRC suspend indications for the one or more second terminal devices.

In an embodiment of the disclosure, the more than one second requests may be used for the first terminal device and the one or more second terminal devices respectively.

In an embodiment of the disclosure, the base station may comprise a distributed unit (DU) and a central unit (CU).

In an embodiment of the disclosure, the method may further comprise, when determining that the first terminal device should enter RRC non-connected state, sending, by the control plane to the DU, one or more third requests for bearer context release.

In an embodiment of the disclosure, the one third request may comprise an RRC release message having suspend configurations for the first terminal device and the one or more second terminal devices.

In an embodiment of the disclosure, the one third request may comprise an RRC release message that has a suspend configuration for the first terminal device, but has no suspend configurations for the one or more second terminal devices.

In an embodiment of the disclosure, the more than one third requests may comprise more than one RRC release messages used for the first terminal device and the one or more second terminal devices respectively.

In an embodiment of the disclosure, the third request comprising the RRC release message used for the first terminal device may be sent to the DU when the one or more second terminal devices have been transferred to RRC non-connected state.

According to a third aspect of the disclosure, there is provided a method performed by a base station. The method comprises receiving, by a control plane of the base station from a user plane of the base station, information related to a traffic condition of a first terminal device that acts as a terminal device to network relay for one or more second terminal devices. The method further comprises determining, by the control plane, whether the first terminal device should enter RRC non-connected state based on the received information. The method further comprises, when determining that the first terminal device should enter RRC non-connected state, determining, by the control plane, whether at least one of the one or more second terminal devices is in RRC connected state. The method further comprises, when determining that at least one of the one or more second terminal devices is in RRC connected state, sending, by the control plane to the at least one second terminal device, a first request instructing to attempt path switching.

In an embodiment of the disclosure, the first request may indicate a cause for instructing to attempt path switching.

In an embodiment of the disclosure, the method may further comprise, when path switching is successful for the at least one second terminal device, transferring, by the control plane, the first terminal device to RRC non-connected state.

In an embodiment of the disclosure, transferring the first terminal device to RRC non-connected state may comprise sending a second request for bearer context modification for the first terminal device to the user plane.

In an embodiment of the disclosure, the base station may comprise a DU and a CU.

In an embodiment of the disclosure, transferring the first terminal device to RRC non-connected state may comprise sending a third request for bearer context release for the first terminal device to the DU.

According to a fourth aspect of the disclosure, there is provided a method performed by a base station. The method comprises configuring, by a control plane of the base station, a first inactivity timer to a first terminal device that acts as a terminal device to network relay for one or more second terminal devices. The method further comprises configuring, by the control plane, one or more second inactivity timers to the one or more second terminal devices. A value of the first inactivity timer is greater than values of the one or more second inactivity timers such that when the first terminal device enters RRC non-connected state, the one or more second terminal devices have been transferred to RRC non-connected state.

According to a fifth aspect of the disclosure, there is provided a method performed by a base station. The method comprises receiving, by a DU of the base station from a control plane of the base station, one or more requests for bearer context release. The one or more requests comprise one or more RRC release messages for one or more second terminal devices in RRC connected state and a first terminal device that acts as a terminal device to network relay for the one or more second terminal devices. The method further comprises transferring, by the DU, the one or more RRC release messages.

In an embodiment of the disclosure, the one request may comprise the one RRC release message having suspend configurations for the first terminal device and the one or more second terminal devices. The one RRC release message may be transferred to the first terminal device.

In an embodiment of the disclosure, the one request may comprise the one RRC release message that has a suspend configuration for the first terminal device, but has no suspend configurations for the one or more second terminal devices. The one or more second terminal devices may be determined to enter RRC non-connected state, according to the suspend configuration for the first terminal device. The one RRC release message may be transferred to the first terminal device.

In an embodiment of the disclosure, the more than one requests may comprise the more than one RRC release messages used for the first terminal device and the one or more second terminal devices respectively. The more than one RRC release messages may be transferred to the first terminal device and the one or more second terminal devices respectively.

In an embodiment of the disclosure, the RRC release message used for the first terminal device may be transferred to the first terminal device when the one or more second terminal devices have been transferred to RRC non-connected state.

In an embodiment of the disclosure, the method may further comprise, when the first terminal device and the one or more second terminal devices have been transferred to RRC non-connected state, sending, by the DU to the control plane, a notification message about completion of bearer context release.

In an embodiment of the disclosure, the notification message may comprise terminal device IDs of the first terminal device and the one or more second terminal devices.

In an embodiment of the disclosure, the notification message may comprise a terminal device ID of the first terminal device, but comprises no terminal device IDs of the one or more second terminal devices.

According to a sixth aspect of the disclosure, there is provided a method performed by a first terminal device. The first terminal device acts as a terminal device to network relay for one or more second terminal devices in RRC connected state. The method comprises receiving, from a DU of a base station, an RRC release message. The method further comprises sending one or more notification messages to the one or more second terminal devices.

In an embodiment of the disclosure, the RRC release message may have suspend configurations for the first terminal device and the one or more second terminal devices. The one or more notification messages may comprise the suspend configurations for the one or more second terminal devices respectively.

In an embodiment of the disclosure, the RRC release message may have a suspend configuration for the first terminal device, but have no suspend configurations for the one or more second terminal devices. The one or more notification messages may indicate that the one or more second terminal devices should enter RRC non-connected state respectively, or indicate that the first terminal device is to enter RRC non-connected state.

According to a seventh aspect of the disclosure, there is provided a method performed by a first terminal device. The first terminal device acts as a terminal device to network relay for one or more second terminal devices. The method comprises determining whether to enter RRC non-connected state based on an inactivity timer. The method further comprises, when determining to enter RRC non-connected state, informing the one or more second terminal devices that the first terminal device is to enter RRC non-connected state.

In an embodiment of the disclosure, the method may further comprise entering RRC non-connected state when the inactivity timer expires and the one or more second terminal devices are in RRC non-connected state.

According to an eighth aspect of the disclosure, there is provided a method performed by a second terminal device. The second terminal device in RRC connected state connects to a network via a first terminal device acting as a terminal device to network relay. The method comprises receiving a notification message from the first terminal device. The method further comprises performing a predetermined action in response to the notification message.

In an embodiment of the disclosure, the notification message may comprise a suspend configuration for the second terminal device. The predetermined action may be one of: entering RRC non-connected state; and confirming with the network whether the second terminal device should enter RRC non-connected state.

In an embodiment of the disclosure, the notification message may indicate that the second terminal device should enter RRC non-connected state. The predetermined action may be confirming with the network whether the second terminal device should enter RRC non-connected state.

In an embodiment of the disclosure, the notification message may indicate that the first terminal device is to enter RRC non-connected state. The predetermined action may be one of: entering RRC non-connected state; confirming with the network whether the second terminal device should enter RRC non-connected state; and attempting path switching to a direct path or an indirect path via a different third terminal device acting as a terminal device to network relay.

In an embodiment of the disclosure, the second terminal device may be configured with an inactivity timer. The inactivity timer may start when transmitting or receiving a medium access control (MAC) PDU containing traffic that aims to be communicated between the second terminal device and the network and is forwarded by the first terminal device.

According to a ninth aspect of the disclosure, there is provided a method performed by a second terminal device. The second terminal device in RRC connected state connects to a network via a first terminal device acting as a terminal device to network relay. The method comprises receiving, from a control plane of a base station, a request instructing to attempt path switching. The method further comprises attempting path switching in response to the request.

In an embodiment of the disclosure, the method may further comprise sending a measurement report to the control plane.

According to a tenth aspect of the disclosure, there is provided a base station. The base station comprises at least one processor and at least one memory. The at least one memory contains instructions executable by the at least one processor, whereby the base station is operative to determine, by a user plane of the base station, whether a first terminal device that acts as a terminal device to network relay for one or more second terminal devices in RRC connected state is inactive, based on traffic conditions of the first terminal device and the one or more second terminal devices. The base station is further operative to report, by the user plane, a result of the determination to a control plane of the base station.

In an embodiment of the disclosure, the base station may be operative to perform the method according to the above first aspect.

According to an eleventh aspect of the disclosure, there is provided a base station. The base station comprises at least one processor and at least one memory. The at least one memory contains instructions executable by the at least one processor, whereby the base station is operative to receive, by a control plane of the base station from a user plane of the base station, information related to traffic conditions of one or more second terminal devices in RRC connected state and a first terminal device that acts as a terminal device to network relay for the one or more second terminal devices. The apparatus is further operative to determine, by the control plane, whether the first terminal device should enter RRC non-connected state based on the received information.

In an embodiment of the disclosure, the base station may be operative to perform the method according to the above second aspect.

According to a twelfth aspect of the disclosure, there is provided a base station. The base station comprises at least one processor and at least one memory. The at least one memory contains instructions executable by the at least one processor, whereby the base station is operative to receive, by a control plane of the base station from a user plane of the base station, information related to a traffic condition of a first terminal device that acts as a terminal device to network relay for one or more second terminal devices. The base station is further operative to determine, by the control plane, whether the first terminal device should enter RRC non-connected state based on the received information. The base station is further operative to, when determining that the first terminal device should enter RRC non-connected state, determine, by the control plane, whether at least one of the one or more second terminal devices is in RRC connected state. The base station is further operative to, when determining that at least one of the one or more second terminal devices is in RRC connected state, send, by the control plane to the at least one second terminal device, a first request instructing to attempt path switching.

In an embodiment of the disclosure, the base station may be operative to perform the method according to the above third aspect.

According to a thirteenth aspect of the disclosure, there is provided a base station. The base station comprises at least one processor and at least one memory. The at least one memory contains instructions executable by the at least one processor, whereby the base station is operative to configure, by a control plane of the base station, a first inactivity timer to a first terminal device that acts as a terminal device to network relay for one or more second terminal devices. The base station is further operative to configure, by the control plane, one or more second inactivity timers to the one or more second terminal devices. A value of the first inactivity timer is greater than values of the one or more second inactivity timers such that when the first terminal device enters RRC non-connected state, the one or more second terminal devices have been transferred to RRC non-connected state.

According to a fourteenth aspect of the disclosure, there is provided a base station. The base station comprises at least one processor and at least one memory. The at least one memory contains instructions executable by the at least one processor, whereby the base station is operative to receive, by a DU of the base station from a control plane of the base station, one or more requests for bearer context release. The one or more requests comprise one or more RRC release messages for one or more second terminal devices in RRC connected state and a first terminal device that acts as a terminal device to network relay for the one or more second terminal devices. The base station is further operative to transfer, by the DU, the one or more RRC release messages.

In an embodiment of the disclosure, the base station may be operative to perform the method according to the above fifth aspect.

According to a fifteenth aspect of the disclosure, there is provided a first terminal device. The first terminal device acts as a terminal device to network relay for one or more second terminal devices in RRC connected state. The first terminal device comprises at least one processor and at least one memory. The at least one memory contains instructions executable by the at least one processor, whereby the first terminal device is operative to receive, from a DU of a base station, an RRC release message. The first terminal device is further operative to send one or more notification messages to the one or more second terminal devices.

In an embodiment of the disclosure, the first terminal device may be operative to perform the method according to the above sixth aspect.

According to a sixteenth aspect of the disclosure, there is provided a first terminal device. The first terminal device acts as a terminal device to network relay for one or more second terminal devices. The first terminal device comprises at least one processor and at least one memory. The at least one memory contains instructions executable by the at least one processor, whereby the first terminal device is operative to determine whether to enter RRC non-connected state based on an inactivity timer. The first terminal device is further operative to, when determining to enter RRC non-connected state, inform the one or more second terminal devices that the first terminal device is to enter RRC non-connected state.

In an embodiment of the disclosure, the first terminal device may be operative to perform the method according to the above seventh aspect.

According to a seventeenth aspect of the disclosure, there is provided a second terminal device. The second terminal device in RRC connected state connects to a network via a first terminal device acting as a terminal device to network relay. The second terminal device comprises at least one processor and at least one memory. The at least one memory contains instructions executable by the at least one processor, whereby the second terminal device is operative to receive a notification message from the first terminal device. The second terminal device is further operative to perform a predetermined action in response to the notification message.

In an embodiment of the disclosure, the second terminal device may be operative to perform the method according to the above eighth aspect.

According to an eighteenth aspect of the disclosure, there is provided a second terminal device. The second terminal device in RRC connected state connects to a network via a first terminal device acting as a terminal device to network relay. The second terminal device comprises at least one processor and at least one memory. The at least one memory contains instructions executable by the at least one processor, whereby the second terminal device is operative to receive, from a control plane of a base station, a request instructing to attempt path switching. The second terminal device is further operative to attempt path switching in response to the request.

In an embodiment of the disclosure, the second terminal device may be operative to perform the method according to the above ninth aspect.

According to a nineteenth aspect of the disclosure, there is provided a computer program product. The computer program product comprises instructions which when executed by at least one processor, cause the at least one processor to perform the method according to any of the above first to ninth aspects.

According to a twentieth aspect of the disclosure, there is provided a computer readable storage medium. The computer readable storage medium comprises instructions which when executed by at least one processor, cause the at least one processor to perform the method according to any of the above first to ninth aspects.

According to a twenty-first aspect of the disclosure, there is provided a base station. The base station comprises a determination module for determining, by a user plane of the base station, whether a first terminal device that acts as a terminal device to network relay for one or more second terminal devices in RRC connected state is inactive, based on traffic conditions of the first terminal device and the one or more second terminal devices. The base station further comprises a reporting module for reporting, by the user plane, a result of the determination to a control plane of the base station.

According to a twenty-second aspect of the disclosure, there is provided a base station. The base station comprises a reception module for receiving, by a control plane of the base station from a user plane of the base station, information related to traffic conditions of one or more second terminal devices in RRC connected state and a first terminal device that acts as a terminal device to network relay for the one or more second terminal devices. The base station further comprises a determination module for determining, by the control plane, whether the first terminal device should enter RRC non-connected state based on the received information.

According to a twenty-third aspect of the disclosure, there is provided a base station. The base station comprises a reception module for receiving, by a control plane of the base station from a user plane of the base station, information related to a traffic condition of a first terminal device that acts as a terminal device to network relay for one or more second terminal devices. The base station further comprises a first determination module for determining, by the control plane, whether the first terminal device should enter RRC non-connected state based on the received information. The base station further comprises a second determination module for, when determining that the first terminal device should enter RRC non-connected state, determining, by the control plane, whether at least one of the one or more second terminal devices is in RRC connected state. The base station further comprises a sending module for, when determining that at least one of the one or more second terminal devices is in RRC connected state, sending, by the control plane to the at least one second terminal device, a first request instructing to attempt path switching.

According to a twenty-fourth aspect of the disclosure, there is provided a base station. The base station comprises a first configuration module for configuring, by a control plane of the base station, a first inactivity timer to a first terminal device that acts as a terminal device to network relay for one or more second terminal devices. The base station further comprises a second configuration module for configuring, by the control plane, one or more second inactivity timers to the one or more second terminal devices. A value of the first inactivity timer is greater than values of the one or more second inactivity timers such that when the first terminal device enters RRC non-connected state, the one or more second terminal devices have been transferred to RRC non-connected state.

According to a twenty-fifth aspect of the disclosure, there is provided a base station. The base station comprises a reception module for receiving, by a DU of the base station from a control plane of the base station, one or more requests for bearer context release. The one or more requests comprise one or more RRC release messages for one or more second terminal devices in RRC connected state and a first terminal device that acts as a terminal device to network relay for the one or more second terminal devices. The base station further comprises a transferring module for transferring, by the DU, the one or more RRC release messages.

According to a twenty-sixth aspect of the disclosure, there is provided a first terminal device. The first terminal device acts as a terminal device to network relay for one or more second terminal devices in RRC connected state. The first terminal device comprises a reception module for receiving, from a DU of a base station, an RRC release message. The first terminal device further comprises a sending module for sending one or more notification messages to the one or more second terminal devices.

According to a twenty-seventh aspect of the disclosure, there is provided a first terminal device. The first terminal device acts as a terminal device to network relay for one or more second terminal devices. The first terminal device comprises a determination module for determining whether to enter RRC non-connected state based on an inactivity timer. The first terminal device further comprises an informing module for, when determining to enter RRC non-connected state, informing the one or more second terminal devices that the first terminal device is to enter RRC non-connected state.

According to a twenty-eighth aspect of the disclosure, there is provided a second terminal device. The second terminal device in RRC connected state connects to a network via a first terminal device acting as a terminal device to network relay. The second terminal device comprises a reception module for receiving a notification message from the first terminal device. The second terminal device further comprises a performing module for performing a predetermined action in response to the notification message.

According to a twenty-ninth aspect of the disclosure, there is provided a second terminal device. The second terminal device in RRC connected state connects to a network via a first terminal device acting as a terminal device to network relay. The second terminal device comprises a reception module for receiving, from a control plane of a base station, a request instructing to attempt path switching. The second terminal device further comprises a path switching module for attempting path switching in response to the request.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 is a diagram illustrating the user plane radio protocol stack for a layer 2 evolved UE-to-network relay;

FIG. 2 is a diagram illustrating the control plane radio protocol stack for a layer 2 evolved UE-to-network relay;

FIG. 3 is a diagram illustrating an example of unicast communication over PC5 interface;

FIG. 4 is a flowchart illustrating an existing transitioning process from RRC connected state to RRC inactive state;

FIG. 5 is a diagram illustrating the structure of a gNB;

FIG. 6 is a flowchart illustrating a method performed by a base station according to an embodiment of the disclosure;

FIG. 7 is a flowchart illustrating a method performed by a base station according to an embodiment of the disclosure;

FIG. 8 is a flowchart illustrating a method performed by a base station according to an embodiment of the disclosure;

FIG. 9 is a flowchart illustrating a method performed by a base station according to an embodiment of the disclosure;

FIG. 10 is a flowchart illustrating a method performed by a base station according to an embodiment of the disclosure;

FIG. 11 is a flowchart illustrating a method performed by a base station according to an embodiment of the disclosure;

FIG. 12 is a flowchart illustrating a method performed by a base station according to an embodiment of the disclosure;

FIG. 13 is a flowchart illustrating a method performed by a base station according to an embodiment of the disclosure;

FIG. 14 is a flowchart illustrating a method performed by a base station according to an embodiment of the disclosure;

FIG. 15 is a flowchart illustrating a method performed by a base station according to an embodiment of the disclosure;

FIG. 16 is a flowchart illustrating a method performed by a first terminal device according to an embodiment of the disclosure;

FIG. 17 is a flowchart illustrating a method performed by a first terminal device according to an embodiment of the disclosure;

FIG. 18 is a flowchart illustrating a method performed by a first terminal device according to an embodiment of the disclosure;

FIG. 19 is a flowchart illustrating a method performed by a second terminal device according to an embodiment of the disclosure;

FIG. 20 is a flowchart illustrating a method performed by a second terminal device according to an embodiment of the disclosure;

FIG. 21 is a flowchart illustrating a method performed by a second terminal device according to an embodiment of the disclosure;

FIG. 22 is a block diagram showing an apparatus suitable for use in practicing some embodiments of the disclosure;

FIG. 23 is a block diagram showing a base station according to an embodiment of the disclosure;

FIG. 24 is a block diagram showing a base station according to an embodiment of the disclosure;

FIG. 25 is a block diagram showing a base station according to an embodiment of the disclosure;

FIG. 26 is a block diagram showing a base station according to an embodiment of the disclosure;

FIG. 27 is a block diagram showing a base station according to an embodiment of the disclosure;

FIG. 28 is a block diagram showing a first terminal device according to an embodiment of the disclosure;

FIG. 29 is a block diagram showing a first terminal device according to an embodiment of the disclosure;

FIG. 30 is a block diagram showing a second terminal device according to an embodiment of the disclosure; and

FIG. 31 is a block diagram showing a second terminal device according to an embodiment of the disclosure.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

The term “base station (BS)” may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth. A base station may comprise a central unit (CU) including CU user plane (UP) and CU control plane (CP) and one or more distributed units (DU). The CU and DU(s) may co-locate in a same network node, e.g. a same base station.

The term “terminal device” refers to any end device that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

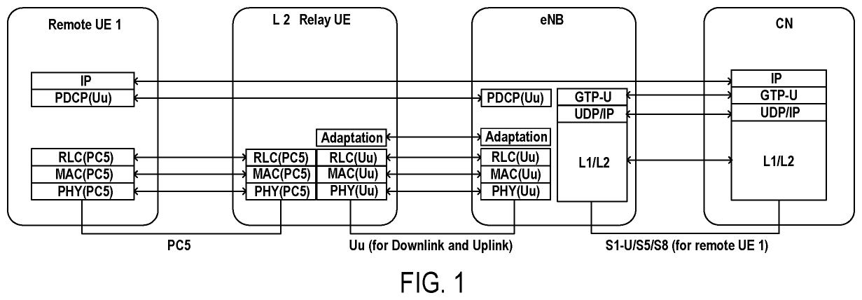

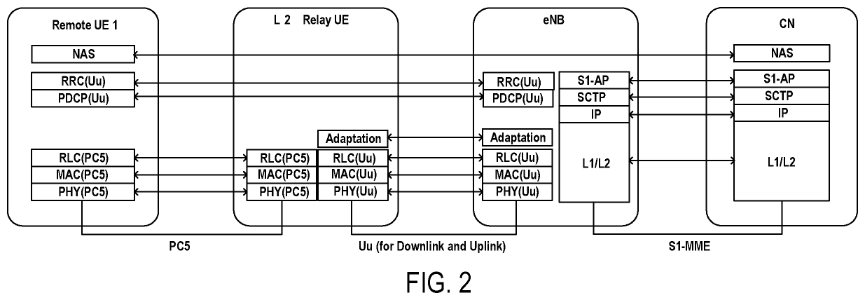

In Rel. 14 & 15 of the 3GPP, a layer 2 evolved UE-to-Network Relay is introduced in evolved packet system (EPS). As shown in FIG. 1 and FIG. 2 which illustrate the user plane protocol stack and the control plane protocol stack for a layer 2 evolved UE-to-Network Relay (see 3GPP TR 36.746 v15.1.1, section 5.1.1), the remote UE's user plane and control plane data are relayed above radio link control (RLC) via the linked evolved UE-to-Network Relay UE. The term “linked” means that the short range link (e.g. PC5) is set up between the evolved ProSe Remote UE and the evolved ProSe UE-to-Network Relay UE and both UEs can exchange data in any direction. Packet data convergence protocol (PDCP) and RRC are terminated between the evolved Remote UE and the evolved node B (eNB) while RLC, MAC and physical layer (PHY) are terminated in each hop. The adaptation layer between the evolved UE-to-Network Relay UE and the eNB is able to differentiate between Uu bearers of a particular evolved Remote UE. Different evolved Remote UEs and different Uu bearers of the evolved Remote UE are indicated by additional information (e.g. UE IDs and bearer IDs) included in adaptation layer header which is added to PDCP PDU. The adaptation layer can be considered as part of PDCP sublayer or a separate new layer between PDCP sublayer and RLC sublayer.

One functionality of the adaptation layer is mapping bearers associated with similar quality of service (QoS) characteristics into the same logical channel (LCH) in the Uu interface between the layer 2 evolved UE-to-Network Relay and the eNB. The bearers may target one or more remote UE(s) or the layer 2 evolved UE-to-Network Relay. In the PC5 interface, different Uu bearers of an evolved Remote UE are distinguished by different sidelink logical channel identities (LCIDs). In the 5th generation system (5GS), this layer 2 based UE-to-Network Relay implemented via. an adaptation layer between RLC and PDCP can also be applied.

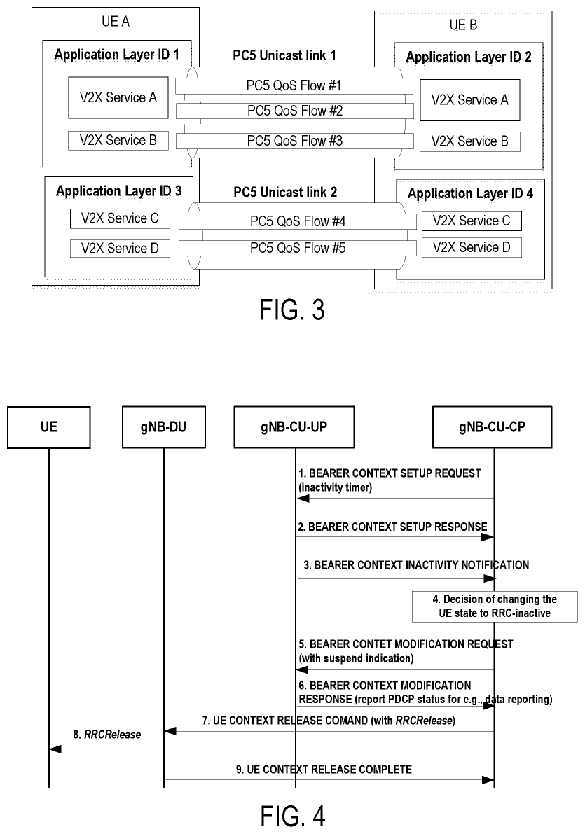

FIG. 3 illustrates an example of unicast communication over PC5 interface (see 3GPP TS 23.287, V2.0.0, section 5.2.1.4). As shown, a PC5 unicast link between two UEs allows V2X communication between one or more pairs of peer V2X services in these UEs. All V2X services in the UE using the same PC5 unicast link use the same Application Layer ID. A source UE is not required to know whether different target Application Layer IDs over different PC5 unicast links belong to the same target UE. For every PC5 unicast link, a UE self-assigns a distinct PC5 Link Identifier that uniquely identifies the PC5 unicast link in the UE for the lifetime of the PC5 unicast link. A PC5 unicast link supports per-flow QoS model. For each V2X service, a set of PC5 QoS Flow Identifier(s) (PFI(s)) is provided. Each PFI is associated with QoS parameters (i.e. PQI and optionally Range). The term PQI refers to PC5 5QI and the term 5GI refers to 5G QoS identifier.

As defined in 3GPP TS 38.401, V16.0.0, section 8.9.6.1, a next generation node B (gNB) can trigger a transition of a UE from RRC_CONNECTED to RRC_INACTIVE. RRC_INACTIVE is a state where a UE remains in connection management connected (CM-CONNECTED) and can move within an area configured by next generation radio access network (NG-RAN) (i.e. RAN notification area (RNA)) without notifying NG-RAN. In RRC_INACTIVE, the last serving gNB node keeps the UE context and the UE-associated NG connection with the serving access and mobility management function (AMF) and user plane function (UPF). UE in RRC_INACTIVE should monitor a Paging channel for core network (CN) paging using 5G system architecture evolution (SAE) temporary mobile subscriber identity (5G-S-TMSI) and RAN paging using full inactive radio network temporary identity (I-RNTI).

The procedure for changing the UE state from RRC_CONNECTED to RRC_INACTIVE is shown in FIG. 4. The CU-CP shown in the figure refers to central unit control plane, the CU-UP refers to central unit user plane, and the DU refers to distributed unit. At step 1, the gNB-CU-CP sends BEARER CONTEXT SETUP REQUEST message with UE or PDU session or DRB level inactivity timer, which implies a UE or PDU session or DRB level inactivity monitoring. At step 2, the gNB-CU-UP sends BEARER CONTEXT SETUP RESPONSE message. At step 3, the gNB-CU-UP sends BEARER CONTEXT INACTIVITY NOTIFICATION message with inactivity monitoring results. At step 4, the gNB-CU-CP determines that the UE should enter RRC_INACTIVE after receiving BEARER CONTEXT INACTIVITY NOTIFICATION message over E1 interface. At step 5, the gNB-CU-CP sends BEARER CONTEXT MODIFICATION REQUEST message with a RRC Suspend indication to the gNB-CU-UP, which indicates that the UE is entering RCC-inactive state. The gNB-CU-CP keeps the F1 uplink (UL) tunnel endpoint identifiers (TEIDs). At step 6, the gNB-CU-UP sends the BEARER CONTEXT MODIFICATION RESPONSE message including the PDCP UL and downlink (DL) status that may be needed for e.g., data volume reporting. The gNB-CU-UP keeps the Bearer Context, the UE-associated logical E1-connection, the next generation user-plane (NG-U) related resource (e.g., NG-U DL TEIDs) and the F1 UL TEIDs. At step 7, the gNB-CU-CP sends the UE CONTEXT RELEASE COMMAND message to the gNB-DU serving the UE, together with the RRCRelease message to be sent to the UE, where the RRCRelease message includes a suspendConfig information element (IE). At step 8, the gNB-DU sends the RRCRelease message to the UE. The UE applies the received suspendConfig, resets MAC, re-establishes RLC entities for SRB1, suspends all signaling radio bear(s) (SRB(s)) and DRB(s) except SRB0, and enters RRC_INACTIVE. At step 9, the gNB-DU sends the UE CONTEXT RELEASE COMPLETE message to the gNB-CU-CP.

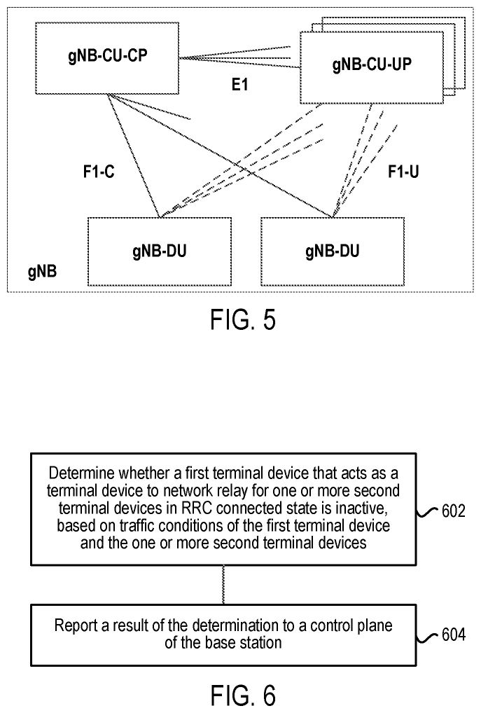

One example of the structure for the gNB shown in FIG. 4 is illustrated in FIG. 5. As shown, a gNB may comprise a gNB-CU-CP, multiple gNB-CU-UPs and multiple gNB-DUs. As defined in 3GPP TS 38.401, the gNB-CU-CP is connected to the gNB-DU through the F1-C interface. The gNB-CU-UP is connected to the gNB-DU through the F1-U interface. The gNB-CU-UP is connected to the gNB-CU-CP through the E1 interface. One gNB-DU is connected to only one gNB-CU-CP. One gNB-CU-UP is connected to only one gNB-CU-CP. One gNB-DU can be connected to multiple gNB-CU-UPs under the control of the same gNB-CU-CP. One gNB-CU-UP can be connected to multiple DUs under the control of the same gNB-CU-CP.

As defined in 3GPP TS 38.321 v16.0.0, UE can trigger a transition of a UE from RRC connected to RRC idle. Specifically, the UE may be configured by RRC with a Data inactivity monitoring functionality, when in RRC_CONNECTED. RRC controls Data inactivity operation by configuring the timer dataInactivityTimer. When dataInactivityTimer is configured, the UE shall start or restart dataInactivityTimer if any MAC entity receives a MAC service data unit (SDU) for dedicated traffic channel (DTCH) logical channel, dedicated control channel (DCCH) logical channel, or common control channel (CCCH) logical channel; or if any MAC entity transmits a MAC SDU for DTCH logical channel, or DCCH logical channel, regardless of listen before talk (LBT) failure indication from lower layers. If the dataInactivityTimer expires, the UE shall indicate the expiry of the dataInactivityTimer to upper layers. According to 3GPP TS 38.331, upon receiving the expiry of DataInactivityTimer from lower layers while in RRC_CONNECTED, the UE shall perform the actions upon going to RRC_IDLE, with release cause ‘RRC connection failure’.

Based on the above, a UE in RRC_INACTIVE/RRC_IDLE will suspend/release all SRB(s) and DRB(s) (except SRB0 when in RRC_INACTIVE). With the current inactivity monitoring at gNB and/or UE it could happen that a relay UE is sent to (or transferred to) RRC_INACTIVE or RRC_IDLE while the linked remote UE(s) are still in RRC_CONNECTED. In this case, the relay UE cannot relay traffic for the linked remote UE(s), consequently the linked remote UE(s) in RRC_CONNECTED cannot transmit/receive properly to its serving gNB/cell, for both control plane (CP) signaling and user plane (UP) traffic.

The present disclosure proposes an improved solution for controlling connection state of terminal device. One of the basic ideas of the solution is to perform inactivity monitoring for a relay UE taking also the status of the linked remote UE(s) into account. For instance, a relay UE may be regarded as inactive only if there is no traffic from/to both the relay UE and the linked remote UE(s) in RRC_CONNECTED. The relay UE may be sent to RRC_INACTIVE only if both the relay UE and the linked remote UE(s) in RRC_CONNECTED are regarded as inactive. Similarly, the relay UE could only enter RRC_IDLE state only when there are no linked remote UE(s) staying in RRC_CONNECTED. In this way, it can be avoided that a relay UE enters RRC_INACTIVE or RRC_IDLE while some linked remote UE(s) are still in RRC_CONNECTED.

The solution of the present disclosure may be applied to a communication system including a terminal device and a base station. The terminal device can communicate through a radio access communication link with the base station. The base station can provide radio access communication links to terminal devices that are within its communication service cell. The base station may be, for example, a gNB in NR. Note that the communications may be performed between the terminal device and the base station according to any suitable communication standards and protocols. The terminal device may also be referred to as, for example, device, access terminal, user equipment (UE), mobile station, mobile unit, subscriber station, or the like. It may refer to any end device that can access a wireless communication network and receive services therefrom. By way of example and not limitation, the terminal device may include a portable computer, an image capture terminal device such as a digital camera, a gaming terminal device, a music storage and playback appliance, a mobile phone, a cellular phone, a smart phone, a tablet, a wearable device, a personal digital assistant (PDA), or the like.

In an Internet of things (IoT) scenario, a terminal device may represent a machine or other device that performs monitoring and/or measurements, and transmits the results of such monitoring and/or measurements to another terminal device and/or a network equipment. In this case, the terminal device may be a machine-to-machine (M2M) device, which may, in a 3GPP context, be referred to as a machine-type communication (MTC) device. Particular examples of such machines or devices may include sensors, metering devices such as power meters, industrial machineries, bikes, vehicles, or home or personal appliances, e.g. refrigerators, televisions, personal wearables such as watches, and so on.

Now, several embodiments will be described to explain the improved solution for controlling connection state of terminal device. Although these embodiments will be described in the context of 5GS involving NR sidelink communications, those skilled in the art can understand that the principle of the present disclosure can be applicable to any kind of communication system involving direct communications between UEs.

Regarding gNB triggered RRC_CONNECTED to RRC_INACTIVE transition due to inactivity, one main idea is to perform inactivity monitoring for a relay UE taking also the status of the linked remote UE(s) into account, to avoid that the relay UE is sent to RRC_INACTIVE while some linked remote UE(s) are still in RRC_CONNECTED. This could be implemented in the ways described below.

As a first embodiment, a gNB-CU-UP performs only UE level inactivity monitoring or both UE level inactivity monitoring and DRB/PDU session level inactivity monitoring for the relay UE. This may be adopted adaptively, i.e. UE level inactivity monitoring should/must be performed for the relay UE only when there exist remote UE(s) that are in RRC_CONNECTED are linked to the relay UE. The BEARER CONTEXT SETUP REQUEST message could indicate when (at least) UE level inactivity monitoring should/must be performed for the relay UE.

In a sub-embodiment, a relay UE is regarded by the gNB-CU-UP as inactive only if there is no traffic from/to both the relay UE and the linked RRC_CONNECTED remote UE(s) during a certain time period given by the inactivity timer. The inactivity status of the remote UE may only be considered in UE level inactivity monitoring of the relay UE, i.e., DRB/PDU session level inactivity monitoring of the relay UE may not consider the status of the inked remote UE(s).

In another sub-embodiment, UE level inactivity status is indicated for the relay UE in the BEARER CONTEXT INACTIVITY NOTIFICATION message and “inactive” is indicated when the relay UE is regarded as inactive where the status of the linked remote UE(s) are also taken into account as described above. The gNB-CU-CP determines whether a relay UE should enter RRC_INACTIVE only based on the UE level inactivity status of the relay UE received in BEARER CONTEXT INACTIVITY NOTIFICATION message, even both UE level and DRB/PDU session level inactivity status are reported.

In yet another sub-embodiment, when a gNB-CU-CP determines that a relay UE should enter RRC_INACTIVE, all the linked remote UE(s) in RRC_CONNECTED should also enter RRC_INACTIVE.

As a second embodiment, a gNB-CU-UP still performs inactivity monitoring and sends BEARER CONTEXT INACTIVITY NOTIFICATION message independently for each UE/PDU session/DRB as in the prior art, while the gNB-CU-CP determines whether a relay UE should enter RRC_INACTIVE based on activity indicated for both the relay UE and the linked remote UE(s) in RRC_CONNECTED. More specifically, a relay UE should only be sent to RRC_INACTIVE when inactivity is indicated for (all the PDU sessions/DRBs of) the relay UE and also the linked remote UE(s) in RRC_CONNECTED.

In a sub-embodiment, the gNB-CU-CP should not transfer a relay UE to RRC_INACTIVE (i.e. at least one bearer of the relay UE should not be suspended) if at least one of linked remote UE(s) are determined to be kept in RRC_CONNECTED.

As a third embodiment, when a relay UE is determined to be transferred to RRC_INACTIVE (i.e. all bearer(s) of the relay UE are to be suspended), the gNB-CU-CP sends either one BEARER CONTEXT MODIFICATION REQUEST message for both the relay UE and all the linked remote UE(s) that are currently in RRC_CONNECTED, or multiple BEARER CONTEXT MODIFICATION REQUEST messages including RRC Suspend indications for the relay UE and all the linked remote UE(s) in RRC_CONNECTED separately.

In a sub-embodiment, the BEARER CONTEXT MODIFICATION REQUEST message may include the RRC Suspend indications and the associated UE IDs (e.g., relay UE and all linked remote UE(s) in RRC_CONNECTED) used over E1 interface. Alternatively, the BEARER CONTEXT MODIFICATION REQUEST message may only include RRC Suspend indication of the relay UE when the relay UE is determined to be transferred to RRC_INACTIVE, in which case the gNB-CU-UP may be configured to understand it as that all the linked remote UE(s) in RRC_CONNECTED will/should also be sent to RRC_INACTIVE.

As a fourth embodiment, when receiving the UE CONTEXT RELEASE COMMAND message including RRCRelease with suspend configuration for the relay UE, the gNB-DU may be configured to understand it as that all the linked remote UE(s) that are in RRC_CONNECTED will/should also be transferred to RRC_INACTIVE, which implies that the (lower layer) UE context of those remote UE(s) will be released in the gNB_DU. Correspondingly, when receiving RRCRelease containing suspend indication, the relay UE may be configured to understand it as that all the linked remote UE(s) that are in RRC_CONNECTED will/should also be transferred to RRC_INACTIVE.

As a fifth embodiment, the linked remote UEs may be informed to enter RRC-INACTIVE state by using the following options. As a first option, when the relay UE is going to enter RRC_INACTIVE after e.g. receiving RRCRelease message containing the suspend indication, the relay UE sends a PC5-RRC message to inform all linked remote UE(s) in RRC_CONNECTED that they should enter RRC_INACTIVE. The remote UE(s) may confirm this with the NW (e.g. gNB-CU-CP). Alternatively the relay UE may just inform the linked remote UE(s) that it will enter RRC_INACTIVE, and the remote UE(s) check with the NW (e.g. gNB-CU-CP) whether they should enter RRC_INACTIVE.

As a second option, the NW (e.g. gNB-CU-CP) generates multiple RRCRelease messages and sends each message to each of the relay UE and the linked remote UE(s) in RRC_CONNECTED. The NW should send RRCRelease message to the relay UE and transfer it to RRC_INACTIVE only when all the linked remote UEs in RRC_CONNECTED have been transferred to RRC_INACTIVE.

As a third option, the RRCRelease included in UE CONTEXT RELEASE COMMAND message may include suspend configuration of both the relay UE and the linked remote UE(s) which will be sent to RRC_INACTIVE. The relay UE could then forward the remote UEs' suspend configuration over PC5 using a PC5-RRC message. By receiving such PC5-RRC message the remote UE(s) know that they should enter RRC_INACTIVE. Alternatively, the remote UE(s) may confirm this with the NW (e.g. gNB-CU-CP).

As a sixth embodiment, when a relay UE and the linked remote UE(s) in RRC_CONNECTED have been transferred to RRC_INACTIVE, the UE CONTEXT RELEASE COMPLETE message may include F1 UE ID of only the relay UE, or F1 UE ID of both the relay UE and the relevant remote UE(s).

As a seventh embodiment, in order to avoid that a RRC_CONNECTED remote UE is linked to a RRC_INACTIVE relay UE, when a gNB-CU-CP determines that a relay UE should enter RRC-inactive, it does not send the BEARER CONTEXT MODIFICATION REQUEST message and the UE CONTEXT RELEASE COMMAND message immediately. Instead, it checks if there is any remote UE that is in RRC_CONNECTED and linked to the relay UE. If that is the case, the gNB-CU-CP sends a path switching attempt request message to the relevant remote UE(s), which triggers the remote UE(s) to attempt path switching. The BEARER CONTEXT MODIFICATION REQUEST message and the UE CONTEXT RELEASE COMMAND message are sent only If the path switching is successful (i.e. switch to the direct path or an indirect path via a different relay UE) for all the linked remote UE(s) in RRC_CONNECTED.

In a sub-embodiment, upon receiving the path switching attempt request message, the remote UE sends a fresh measurement report to the NW (e.g. gNB-CU-CP). The fresh measurement report means a report of a fresh measurement performed by the remote UE.

In a sub-embodiment, the path switching attempt request message may indicate the cause of the request, e.g. it is intended to send the relay UE to RRC_INACTIVE.

Note that the embodiments described above could equally be applied when gNB sends a UE in RRC_CONNECTED to RRC_IDLE due to e.g. inactivity of the UE.

Regarding the UE triggered RRC_CONNECTED to RRC_IDLE transition due to inactivity, the following embodiments will be described. As an eighth embodiment, when the relay UE (is going to) enter RRC_IDLE, the relay UE informs this to all the linked remote UE(s) in RRC_CONNECTED. Accordingly, those remote UE(s) may: also enter RRC_IDLE or RRC_INACTIVE; or attempt path switching to the direct path or an indirect path via a different relay UE.

As a ninth embodiment, a gNB is configured in a way that once the relay UE enters RRC_IDLE state, all the linked remote UEs are transferred to either RRC_IDLE or RRC_INACTIVE state automatically. For example, the value of the inactivity timer configured to the relay UE may be greater than values of the inactivity timers configured to the remote UE(s) such that when the relay UE enters RRC_IDLE state, the remote UE(s) have been transferred to RRC_IDLE or RRC_INACTIVE state.

As a tenth embodiment, the relay UE and the linked remote UE(s) are configured with dataInactivityTimer of the same or different values. In this case, the relay UE will enter RRC_IDLE state only if: the dataInactivityTimer of the relay UE expires; and all linked remote UEs are in either RRC_IDLE state or RRC_INACTIVE state.

In one sub-embodiment, the dataInactivityTimer of a remote UE starts upon any transmission or reception of MAC PDUs including sidelink (SL) logical channel(s) (LCH(s)) carrying Uu traffic forwarded by the relay UE.

Hereinafter, the solution of the present disclosure will be further described with reference to FIGS. 6-31. FIG. 6 is a flowchart illustrating a method performed by a base station according to an embodiment of the disclosure. For example, the base station may be a gNB including a DU, a CU-UP and a CU-CP. The user plane of the base station may be the CU-CP and the control plane of the base station may be the CU-CP. At block 602, a user plane of the base station determines whether a first terminal device that acts as a terminal device to network relay for one or more second terminal devices in RRC connected state is inactive, based on traffic conditions of the first terminal device and the one or more second terminal devices. For example, the determination at block 602 may be made by performing terminal device level inactivity monitoring for the first terminal device. That is, this terminal device level inactivity monitoring is performed by taking also the traffic condition of the one or more second terminal devices into account. For example, when there is no traffic received from and/or sent to the first terminal device and the one or more second terminal devices during a time period given by an inactivity timer, the first terminal device may be determined as inactive. At block 604, the user plane reports a result of the determination to a control plane of the base station. For example, if the result of the terminal device level inactivity monitoring at block 602 indicates that the first terminal device is inactive, a terminal device level inactivity status may be indicated for the first terminal device. The result of the determination may be reported in a notification message about bearer context inactivity for the first terminal device. With the method of FIG. 6, it can be avoided that the first terminal device enters RRC non-connected state while the one or more second terminal devices are still in RRC connected state.

As another embodiment, the present disclosure may provide a communication system including the base station configured to perform the method of FIG. 6, the first terminal device, and the one or more second terminal devices.

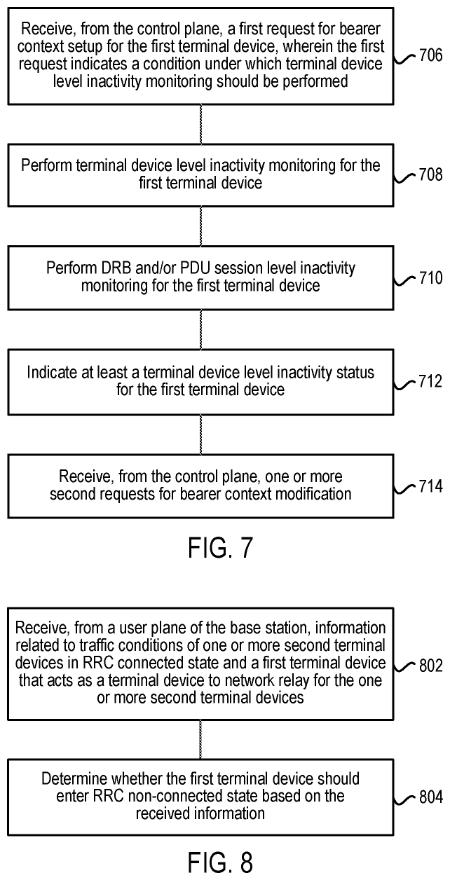

FIG. 7 is a flowchart illustrating a method performed by a base station according to an embodiment of the disclosure. For example, the base station may be a gNB including a DU, a CU-UP and a CU-CP as described above. At block 706, a user plane of the base station receives, from a control plane of the base station, a first request for bearer context setup for the first terminal device. The first request indicates a condition under which terminal device level inactivity monitoring should be performed. For example, the first request may indicate that terminal device level inactivity monitoring should be performed for a terminal device to network relay when there are remote terminal device(s) in RRC connected state connecting to the network via this terminal device to network relay.

At block 708, the user plane performs terminal device level inactivity monitoring for a first terminal device that acts as a terminal device to network relay for one or more second terminal devices in RRC connected state. Since the first terminal device satisfies the condition indicated by the first request, the terminal device level inactivity monitoring is performed for the first terminal device. This terminal device level inactivity monitoring may be performed as described above with respect to block 602.

At block 710, the user plane performs DRB and/or PDU session level inactivity monitoring for the first terminal device. The DRB and/or PDU session level inactivity monitoring may not consider the traffic condition of the one or more second terminal devices. In this way, the traffic condition of the first terminal device alone can be monitored.

At block 712, the user plane indicates at least a terminal device level inactivity status for the first terminal device. For example, the terminal device level inactivity status may be indicated in a notification message about bearer context inactivity for the first terminal device.

At block 714, the user plane receives, from the control plane, one or more second requests for bearer context modification. As a first option, the one second request may comprise RRC suspend indications and terminal device IDs for the first terminal device and the one or more second terminal devices. As a second option, the one second request may comprise an RRC suspend indication for the first terminal device, but comprise no RRC suspend indications for the one or more second terminal devices. In this case, the one or more second terminal devices may be determined to enter RRC non-connected state, based on the RRC suspend indication for the first terminal device. For example, the RRC non-connected state may be RRC inactive state or RRC idle state. As a third option, the more than one second requests may be used for the first terminal device and the one or more second terminal devices respectively.

FIG. 8 is a flowchart illustrating a method performed by a base station according to an embodiment of the disclosure. For example, the base station may be a gNB including a DU, a CU-UP and a CU-CP as described above. At block 802, a control plane of the base station receives, from a user plane of the base station, information related to traffic conditions of one or more second terminal devices in RRC connected state and a first terminal device that acts as a terminal device to network relay for the one or more second terminal devices. At block 804, the control plane determines whether the first terminal device should enter RRC non-connected state based on the received information. Since the traffic conditions of both the first terminal device and the one or more second terminal devices are considered, it can be avoided that the first terminal device enters RRC non-connected state while the one or more second terminal devices are still in RRC connected state.

As a first option, the information related to the traffic conditions of the one or more second terminal devices and the first terminal device may be a terminal device level inactivity status indicated for the first terminal device. In this case, the first terminal device may be determined to enter RRC non-connected state according to the terminal device level inactivity status indicated for the first terminal device at block 804.

As a second option, the information related to the traffic conditions of the one or more second terminal devices and the first terminal device may comprise one or more of: a result of terminal device level inactivity monitoring performed independently for the first terminal device and the one or more second terminal devices; a result of DRB level inactivity monitoring performed for DRBs related to the first terminal device and the one or more second terminal devices; and a result of PDU session level inactivity monitoring performed for PDU sessions related to the first terminal device and the one or more second terminal devices. In this case, the first terminal device may be determined to enter RRC non-connected state at block 804 when one or more of the following conditions are satisfied: the result of the terminal device level inactivity monitoring indicates that the first terminal device and the one or more second terminal devices are inactive; the result of the DRB level inactivity monitoring indicates that (all) the DRBs related to the first terminal device and the one or more second terminal devices are inactive; and the result of the PDU session level inactivity monitoring indicates that (all) the PDU sessions related to the first terminal device and the one or more second terminal devices are inactive.

On the other hand, the first terminal device may be determined not to enter RRC non-connected state at block 804 when at least one of the one or more second terminal devices is determined to be kept in RRC connected state.

As another embodiment, the present disclosure may provide a communication system including the base station configured to perform the method of FIG. 8, the first terminal device, and the one or more second terminal devices.

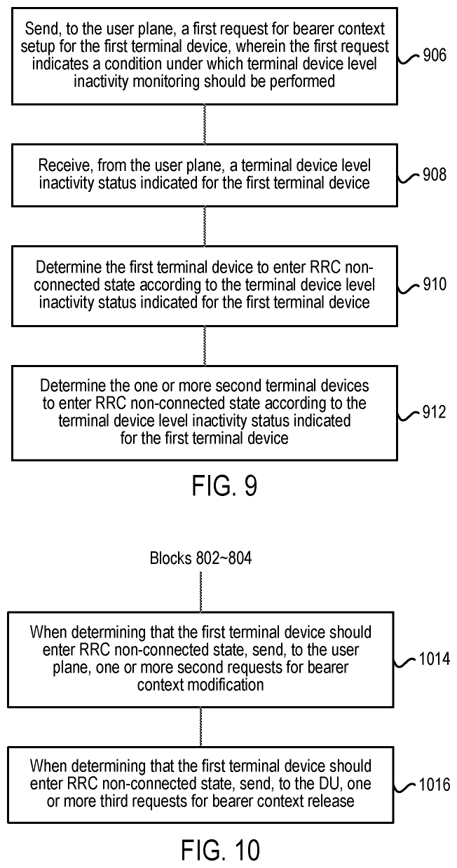

FIG. 9 is a flowchart illustrating a method performed by a base station according to an embodiment of the disclosure. For example, the base station may be a gNB including a DU, a CU-UP and a CU-CP as described above. At block 906, a control plane of the base station sends, to a user plane of the base station, a first request for bearer context setup for a first terminal device that acts as a terminal device to network relay for the one or more second terminal devices in RRC connected state. The first request indicates a condition under which terminal device level inactivity monitoring should be performed. Block 906 corresponds to block 706. At block 908, the control plane receives, from the user plane, a terminal device level inactivity status indicated for the first terminal device. Block 908 corresponds to block 712. At block 910, the control plane determines the first terminal device to enter RRC non-connected state according to the terminal device level inactivity status indicated for the first terminal device. At block 912, the control plane determines the one or more second terminal devices to enter RRC non-connected state according to the terminal device level inactivity status indicated for the first terminal device.

FIG. 10 is a flowchart illustrating a method performed by a base station according to an embodiment of the disclosure. For example, the base station may be a gNB including a DU, a CU-UP and a CU-CP as described above. As shown, the method comprises blocks 802-804 described above and 1014-1016. At block 1014, when determining that the first terminal device should enter RRC non-connected state, the control plane sends, to the user plane, one or more second requests for bearer context modification. As a first option, the one second request may comprise RRC suspend indications and terminal device IDs for the first terminal device and the one or more second terminal devices. As a second option, the one second request may comprise an RRC suspend indication for the first terminal device, but comprise no RRC suspend indications for the one or more second terminal devices. As a third option, the more than one second requests may be used for the first terminal device and the one or more second terminal devices respectively.

At block 1016, when determining that the first terminal device should enter RRC non-connected state, the control plane sends, to a DU of the base station, one or more third requests for bearer context release. As a first option, the one third request may comprise an RRC release message having suspend configurations for the first terminal device and the one or more second terminal devices. As a second option, the one third request may comprise an RRC release message that has a suspend configuration for the first terminal device, but has no suspend configurations for the one or more second terminal devices. As a third option, the more than one third requests may comprise more than one RRC release messages used for the first terminal device and the one or more second terminal devices respectively. For example, the third request comprising the RRC release message used for the first terminal device may be sent to the DU when the one or more second terminal devices have been transferred to RRC non-connected state.

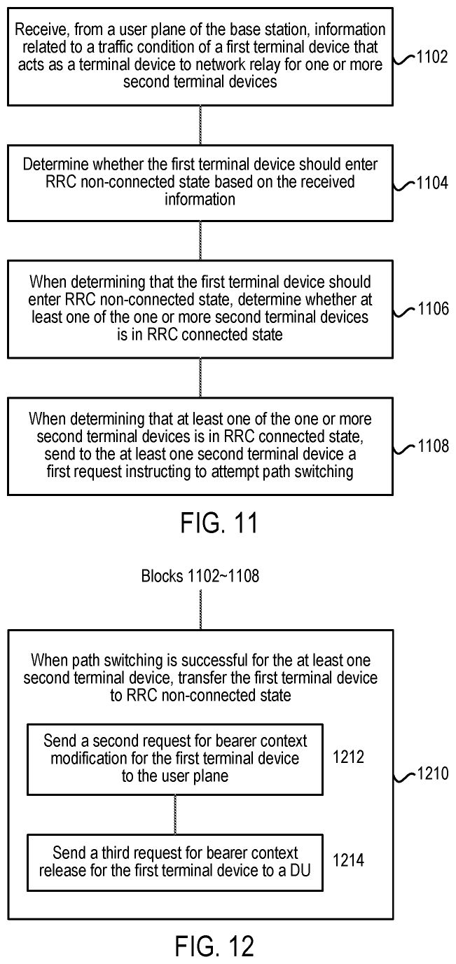

FIG. 11 is a flowchart illustrating a method performed by a base station according to an embodiment of the disclosure. For example, the base station may be a gNB including a DU, a CU-UP and a CU-CP as described above. At block 1102, a control plane of the base station receives, from a user plane of the base station, information related to a traffic condition of a first terminal device that acts as a terminal device to network relay for one or more second terminal devices. For example, the information related to the traffic condition of the first terminal device may comprise one or more of: a result of terminal device level inactivity monitoring performed independently for the first terminal device; a result of DRB level inactivity monitoring performed for DRBs related to the first terminal device; and a result of PDU session level inactivity monitoring performed for PDU sessions related to the first terminal device.

At block 1104, the control plane determines whether the first terminal device should enter RRC non-connected state based on the received information. For example, the first terminal device may be determined to enter RRC non-connected state when one or more of the following conditions are satisfied: the result of the terminal device level inactivity monitoring indicates that the first terminal device is inactive; the result of the DRB level inactivity monitoring indicates that (all) the DRBs related to the first terminal device are inactive; and the result of the PDU session level inactivity monitoring indicates that (all) the PDU sessions related to the first terminal device are inactive.

When determining that the first terminal device should enter RRC non-connected state, the control plane determines (e.g. identifies) whether at least one of the one or more second terminal devices is in RRC connected state at block 1106. When determining that at least one of the one or more second terminal devices is in RRC connected state, the control plane sends to the at least one second terminal device a first request instructing to attempt path switching at block 1108. For example, the first request indicates a cause for instructing to attempt path switching. With the method of FIG. 11, since the at least one second terminal device is instructed to attempt path switching, it is possible to avoid the first terminal device from being improperly transferred to RRC non-connected state.

As another embodiment, the present disclosure may provide a communication system including the base station configured to perform the method of FIG. 11, the first terminal device, and the one or more second terminal devices.

FIG. 12 is a flowchart illustrating a method performed by a base station according to an embodiment of the disclosure. For example, the base station may be a gNB including a DU, a CU-UP and a CU-CP as described above. As shown, the method comprises blocks 1102-1108 described above and 1210. At block 1210, when path switching is successful for the at least one second terminal device, the control plane transfers the first terminal device to RRC non-connected state. For example, block 1210 may comprise blocks 1212 and 1214. At block 1212, the control plane sends a second request for bearer context modification for the first terminal device to the user plane. At block 1214, the control plane sends a third request for bearer context release for the first terminal device to a DU of the base station.

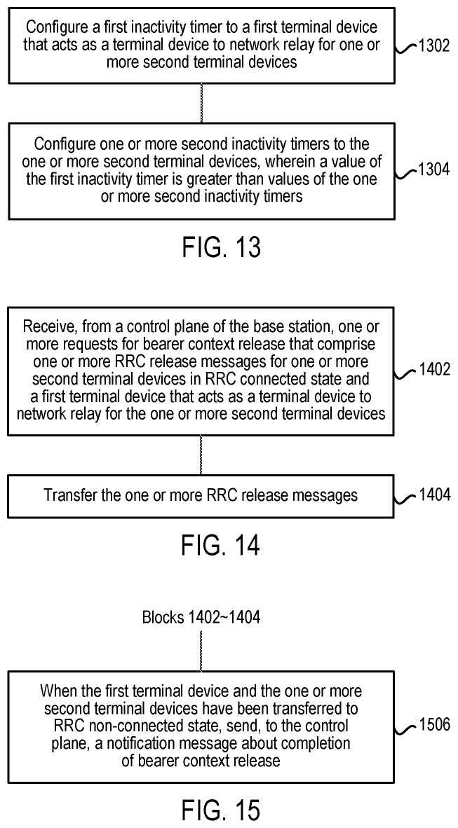

FIG. 13 is a flowchart illustrating a method performed by a base station according to an embodiment of the disclosure. For example, the base station may be a gNB including a DU, a CU-UP and a CU-CP as described above. At block 1302, a control plane of the base station configures a first inactivity timer to a first terminal device that acts as a terminal device to network relay for one or more second terminal devices. At block 1304, the control plane configures one or more second inactivity timers to the one or more second terminal devices. A value of the first inactivity timer may be greater than (e.g. much greater than) values of the one or more second inactivity timers such that when the first terminal device enters RRC non-connected state, the one or more second terminal devices have been transferred to RRC non-connected state. In this way, it can be avoided that the first terminal device enters RRC non-connected state while the one or more second terminal devices are still in RRC connected state.

As another embodiment, the present disclosure may provide a communication system including the base station configured to perform the method of FIG. 13, the first terminal device, and the one or more second terminal devices.

FIG. 14 is a flowchart illustrating a method performed by a base station according to an embodiment of the disclosure. At block 1402, a DU of the base station receives, from a control plane of the base station, one or more requests for bearer context release. The one or more requests comprise one or more RRC release messages for one or more second terminal devices in RRC connected state and a first terminal device that acts as a terminal device to network relay for the one or more second terminal devices. At block 1404, the DU transfers the one or more RRC release messages.

There may be three options for implementing blocks 1402-1404. As the first option, the one request may comprise the one RRC release message having suspend configurations for the first terminal device and the one or more second terminal devices. In this case, the one RRC release message may be transferred to the first terminal device. As the second option, the one request may comprise the one RRC release message that has a suspend configuration for the first terminal device, but has no suspend configurations for the one or more second terminal devices. In this case, the one or more second terminal devices may be determined to enter RRC non-connected state, according to the suspend configuration for the first terminal device. The one RRC release message may be transferred to the first terminal device. As the third option, the more than one requests may comprise the more than one RRC release messages used for the first terminal device and the one or more second terminal devices respectively. In this case, the more than one RRC release messages may be transferred to the first terminal device and the one or more second terminal devices respectively. For example, the RRC release message used for the first terminal device may be transferred to the first terminal device when the one or more second terminal devices have been transferred to RRC non-connected states.

As another embodiment, the present disclosure may provide a communication system including the base station configured to perform the method of FIG. 14, the first terminal device, and the one or more second terminal devices.

FIG. 15 is a flowchart illustrating a method performed by a base station according to an embodiment of the disclosure. As shown, the method comprises blocks 1402-1404 described above and 1506. At block 1506, when the first terminal device and the one or more second terminal devices have been transferred to RRC non-connected state, the DU sends, to the control plane, a notification message about completion of bearer context release. As a first option, the notification message may comprise terminal device IDs of the first terminal device and the one or more second terminal devices. As a second option, the notification message may comprise a terminal device ID of the first terminal device, but comprise no terminal device IDs of the one or more second terminal devices.

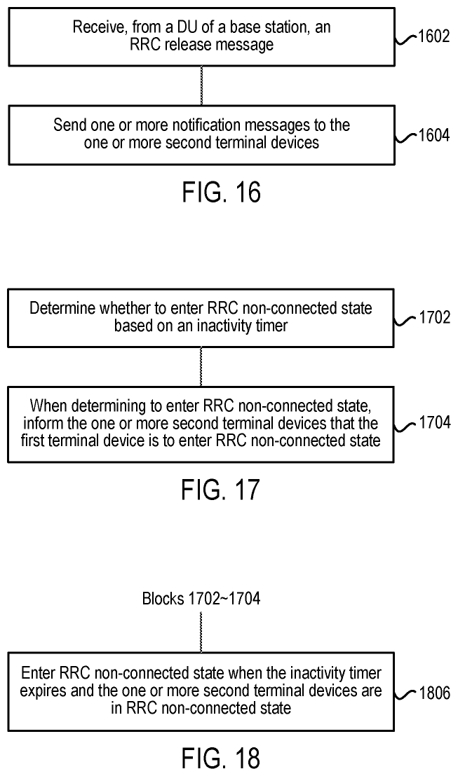

FIG. 16 is a flowchart illustrating a method performed by a first terminal device according to an embodiment of the disclosure. The first terminal device acts as a terminal device to network relay for one or more second terminal devices in RRC connected state. At block 1602, the first terminal device receives, from a DU of a base station, an RRC release message. At block 1604, the first terminal device sends one or more notification messages to the one or more second terminal devices. There may be two options for implementing blocks 1602-1604. As the first option, the RRC release message may have suspend configurations for the first terminal device and the one or more second terminal devices. In this case, the one or more notification messages may comprise the suspend configurations for the one or more second terminal devices respectively. As the second option, the RRC release message may have a suspend configuration for the first terminal device, but have no suspend configurations for the one or more second terminal devices. In this case, the one or more notification messages may indicate that the one or more second terminal devices should enter RRC non-connected state respectively, or indicate that the first terminal device is to enter RRC non-connected state.

As another embodiment, the present disclosure may provide a communication system including the first terminal device configured to perform the method of FIG. 16, the base station, and the one or more second terminal devices.

FIG. 17 is a flowchart illustrating a method performed by a first terminal device according to an embodiment of the disclosure. The first terminal device acts as a terminal device to network relay for one or more second terminal devices. At block 1702, the first terminal device determines whether to enter RRC non-connected state based on an inactivity timer. When determining to enter RRC non-connected state, the first terminal device informs the one or more second terminal devices that the first terminal device is to enter RRC non-connected state at block 1704.

As another embodiment, the present disclosure may provide a communication system including the first terminal device configured to perform the method of FIG. 17, and the one or more second terminal devices.

FIG. 18 is a flowchart illustrating a method performed by a first terminal device according to an embodiment of the disclosure. The first terminal device acts as a terminal device to network relay for one or more second terminal devices. As shown, the method comprises blocks 1702-1704 described above and 1806. At block 1806, the first terminal device enters RRC non-connected state when the inactivity timer expires and the one or more second terminal devices are in RRC non-connected state. With the method of FIG. 18, it can be avoided that the first terminal device enters RRC non-connected state while the one or more second terminal devices are still in RRC connected state.

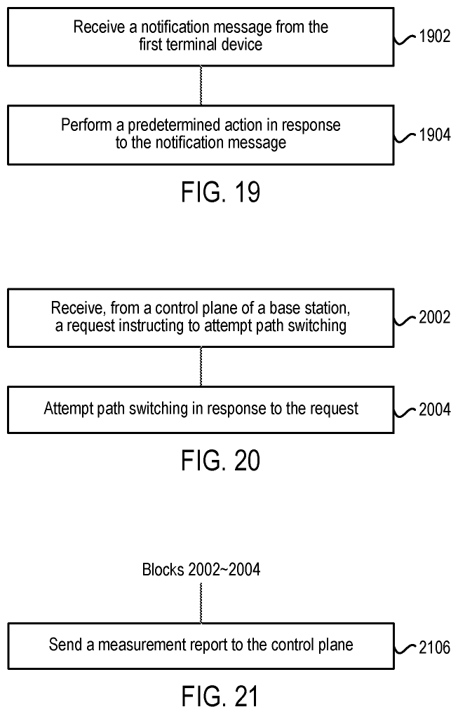

FIG. 19 is a flowchart illustrating a method performed by a second terminal device according to an embodiment of the disclosure. The second terminal device in RRC connected state connects to a network via a first terminal device acting as a terminal device to network relay. At block 1902, the second terminal device receives a notification message from the first terminal device. At block 1904, the second terminal device performs a predetermined action in response to the notification message. There may be three options for implementing blocks 1902-1904. As the first option, the notification message may comprise a suspend configuration for the second terminal device. In this case, the predetermined action may be one of: entering RRC non-connected state; and confirming with the network whether the second terminal device should enter RRC non-connected state. As the second option, the notification message may indicate that the second terminal device should enter RRC non-connected state. In this case, the predetermined action may be confirming with the network whether the second terminal device should enter RRC non-connected state. As the third option, the notification message may indicate that the first terminal device is to enter RRC non-connected state. In this case, the predetermined action may be one of: entering RRC non-connected state; confirming with the network whether the second terminal device should enter RRC non-connected state; and attempting path switching to a direct path or an indirect path via a different third terminal device acting as a terminal device to network relay.

Optionally, the second terminal device may be configured with an inactivity timer. The inactivity timer may start when transmitting or receiving an MAC PDU containing traffic that aims to be communicated between the second terminal device and the network and is forwarded by the first terminal device. Note that the term “start” used here may cover starting or restarting of the inactivity timer.

As another embodiment, the present disclosure may provide a communication system including the second terminal device configured to perform the method of FIG. 19, and the first terminal device.

FIG. 20 is a flowchart illustrating a method performed by a second terminal device according to an embodiment of the disclosure. The second terminal device in RRC connected state connects to a network via a first terminal device acting as a terminal device to network relay. At block 2002, the second terminal device receives, from a control plane of a base station, a request instructing to attempt path switching. At block 2004, the second terminal device attempts path switching in response to the request. For example, the second terminal device may attempt to switch to a direct path or an indirect path via a different third terminal device acting as a terminal device to network relay.

As another embodiment, the present disclosure may provide a communication system including the second terminal device configured to perform the method of FIG. 20, the base station, and the first terminal device.

FIG. 21 is a flowchart illustrating a method performed by a second terminal device according to an embodiment of the disclosure. The second terminal device in RRC connected state connects to a network via a first terminal device acting as a terminal device to network relay. As shown, the method comprises blocks 2002-2004 described above and 2106. At block 2106, the second terminal device sends a measurement report to the control plane.

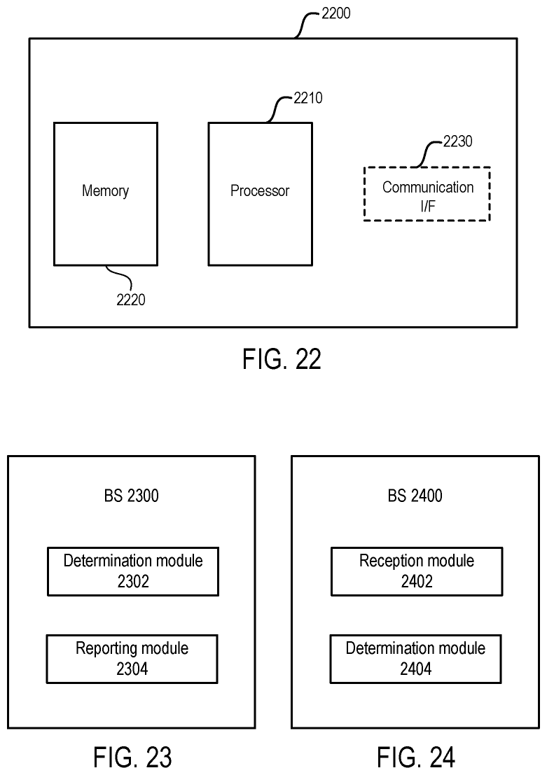

FIG. 22 is a block diagram showing an apparatus suitable for use in practicing some embodiments of the disclosure. For example, any one of the base station, the first terminal device and the second terminal device described above may be implemented through the apparatus 2200. As shown, the apparatus 2200 may include a processor 2210, a memory 2220 that stores a program, and optionally a communication interface 2230 for communicating data with other external devices through wired and/or wireless communication.

The program includes program instructions that, when executed by the processor 2210, enable the apparatus 2200 to operate in accordance with the embodiments of the present disclosure, as discussed above. That is, the embodiments of the present disclosure may be implemented at least in part by computer software executable by the processor 2210, or by hardware, or by a combination of software and hardware.

The memory 2220 may be of any type suitable to the local technical environment and may be implemented using any suitable data storage technology, such as semiconductor based memory devices, flash memories, magnetic memory devices and systems, optical memory devices and systems, fixed memories and removable memories. The processor 2210 may be of any type suitable to the local technical environment, and may include one or more of general purpose computers, special purpose computers, microprocessors, digital signal processors (DSPs) and processors based on multi-core processor architectures, as non-limiting examples.

FIG. 23 is a block diagram showing a base station according to an embodiment of the disclosure. As shown, the base station 2300 comprises a determination module 2302 and a reporting module 2304. The determination module 2302 may be configured to determine, by a user plane of the base station, whether a first terminal device that acts as a terminal device to network relay for one or more second terminal devices in RRC connected state is inactive, based on traffic conditions of the first terminal device and the one or more second terminal devices. The reporting module 2304 may be configured to report, by the user plane, a result of the determination to a control plane of the base station.

FIG. 24 is a block diagram showing a base station according to an embodiment of the disclosure. As shown, the base station 2400 comprises a reception module 2402 and a determination module 2404. The reception module 2402 may be configured to receive, by a control plane of the base station from a user plane of the base station, information related to traffic conditions of one or more second terminal devices in RRC connected state and a first terminal device that acts as a terminal device to network relay for the one or more second terminal devices. The determination module 2404 may be configured to determine, by the control plane, whether the first terminal device should enter RRC non-connected state based on the received information.

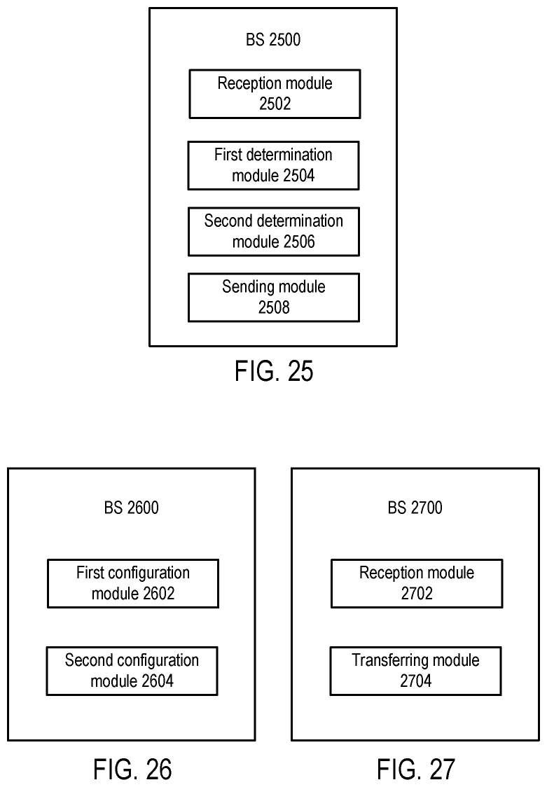

FIG. 25 is a block diagram showing a base station according to an embodiment of the disclosure. As shown, the base station 2500 comprises a reception module 2502, a first determination module 2504, a second determination module 2506 and a sending module 2508. The reception module 2502 may be configured to receive, by a control plane of the base station from a user plane of the base station, information related to a traffic condition of a first terminal device that acts as a terminal device to network relay for one or more second terminal devices. The first determination module 2504 may be configured to determine, by the control plane, whether the first terminal device should enter RRC non-connected state based on the received information. The second determination module 2506 may be configured to, when determining that the first terminal device should enter RRC non-connected state, determine, by the control plane, whether at least one of the one or more second terminal devices is in RRC connected state. The sending module 2508 may be configured to, when determining that at least one of the one or more second terminal devices is in RRC connected state, send, by the control plane to the at least one second terminal device, a first request instructing to attempt path switching.

FIG. 26 is a block diagram showing a base station according to an embodiment of the disclosure. As shown, the base station 2600 comprises a first configuration module 2602 and a second configuration module 2604. The first configuration module 2602 may be configured to configure, by a control plane of the base station, a first inactivity timer to a first terminal device that acts as a terminal device to network relay for one or more second terminal devices. The second configuration module 2604 may be configured to configure, by the control plane, one or more second inactivity timers to the one or more second terminal devices. A value of the first inactivity timer is greater than values of the one or more second inactivity timers such that when the first terminal device enters RRC non-connected state, the one or more second terminal devices have been transferred to RRC non-connected state.

FIG. 27 is a block diagram showing a base station according to an embodiment of the disclosure. As shown, the base station 2700 comprises a reception module 2702 and a transferring module 2704. The reception module 2702 may be configured to receive, by a DU of the base station from a control plane of the base station, one or more requests for bearer context release. The one or more requests comprise one or more RRC release messages for one or more second terminal devices in RRC connected state and a first terminal device that acts as a terminal device to network relay for the one or more second terminal devices. The transferring module 2704 may be configured to transfer, by the DU, the one or more RRC release messages.

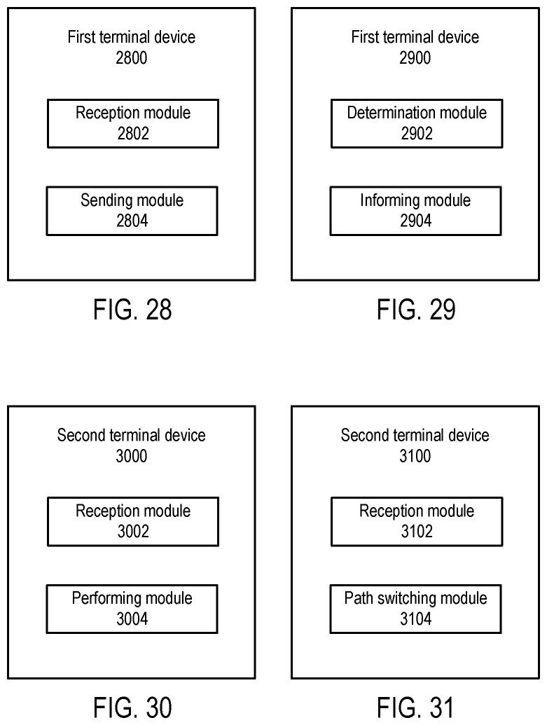

FIG. 28 is a block diagram showing a first terminal device according to an embodiment of the disclosure. The first terminal device acts as a terminal device to network relay for one or more second terminal devices in RRC connected state. As shown, the first terminal device 2800 comprises a reception module 2802 and a sending module 2804. The reception module 2802 may be configured to receive, from a DU of a base station, an RRC release message. The sending module 2804 may be configured to send one or more notification messages to the one or more second terminal devices.

FIG. 29 is a block diagram showing a first terminal device according to an embodiment of the disclosure. The first terminal device acts as a terminal device to network relay for one or more second terminal devices in RRC connected state. As shown, the first terminal device 2900 comprises a determination module 2902 and an informing module 2904. The determination module 2902 may be configured to determine whether to enter RRC non-connected state based on an inactivity timer. The informing module 2904 may be configured to, when determining to enter RRC non-connected state, inform the one or more second terminal devices that the first terminal device is to enter RRC non-connected state.

FIG. 30 is a block diagram showing a second terminal device according to an embodiment of the disclosure. The second terminal device in RRC connected state connects to a network via a first terminal device acting as a terminal device to network relay. As shown, the second terminal device 3000 comprises a reception module 3002 and an performing module 3004. The reception module 3002 may be configured to receive a notification message from the first terminal device. The performing module 3004 may be configured to perform a predetermined action in response to the notification message.

FIG. 31 is a block diagram showing a second terminal device according to an embodiment of the disclosure. The second terminal device in RRC connected state connects to a network via a first terminal device acting as a terminal device to network relay. As shown, the second terminal device 3100 comprises a reception module 3102 and a path switching module 3104. The reception module 3102 may be configured to receive, from a control plane of a base station, a request instructing to attempt path switching. The path switching module 3104 may be configured to attempt path switching in response to the request. The modules described above may be implemented by hardware, or software, or a combination of both.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one skilled in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A method performed by a base station, comprising:
determining, by a user plane of the base station, whether a first terminal device that acts as a terminal device to network relay for one or more second terminal devices in radio resource control (RRC) connected state is inactive, based on traffic conditions of the first terminal device and the one or more second terminal devices during a time period given by an inactivity timer; and
reporting, by the user plane, a result of the determination to a control plane of the base station.

2. The method according to claim 1, wherein the determining whether the first terminal device is inactive comprises:
performing terminal device level inactivity monitoring for the first terminal device.

3. The method according to claim 2, wherein when there is no traffic received from and sent to the first terminal device and the one or more second terminal devices, the first terminal device is determined as inactive.

4. The method according to claim 1, further comprising:
performing, by the user plane, data radio bearer (DRB) or protocol data unit (PDU) session level inactivity monitoring, or both DRB and PDU session level inactivity monitoring for the first terminal device.

5. The method according to claim 2, further comprising:
receiving, by the user plane from the control plane, a first request for bearer context setup for the first terminal device, wherein the first request indicates a condition under which terminal device level inactivity monitoring should be performed; and
wherein the terminal device level inactivity monitoring is performed in response to the first terminal device satisfying the indicated condition.

6. The method according to claim 2, wherein the reporting the result of the determination to the control plane comprises:
indicating at least a terminal device level inactivity status for the first terminal device.

7. The method according to claim 1, further comprising:
receiving, by the user plane from the control plane, one or more second requests for bearer context modification.

8-11. (canceled)

12. A method performed by a base station, comprising:
receiving, by a control plane of the base station from a user plane of the base station, information related to traffic conditions of one or more second terminal devices in radio resource control (RRC) connected state and a first terminal device that acts as a terminal device to network relay for the one or more second terminal devices; and
determining, by the control plane, whether the first terminal device should enter RRC non-connected state based on the received information.

13. The method according to claim 12, wherein the information related to the traffic conditions of the one or more second terminal devices and the first terminal device is a terminal device level inactivity status indicated for the first terminal device; and wherein the first terminal device is determined to enter RRC non-connected state according to the terminal device level inactivity status indicated for the first terminal device.

14. The method according to claim 13, further comprising:
determining, by the control plane, the one or more second terminal devices to enter RRC non-connected state according to the terminal device level inactivity status indicated for the first terminal device.

15. The method according to claim 13, further comprising:
sending, by the control plane to the user plane, a first request for bearer context setup for the first terminal device, wherein the first request indicates a condition under which terminal device level inactivity monitoring should be performed.

16. The method according to claim 12, wherein the information related to the traffic conditions of the one or more second terminal devices and the first terminal device comprises one or more of:
a result of terminal device level inactivity monitoring performed independently for the first terminal device and the one or more second terminal devices;
a result of data radio bearer (DRB) level inactivity monitoring performed for DRB s related to the first terminal device and the one or more second terminal devices; and
a result of protocol data unit (PDU) session level inactivity monitoring performed for PDU sessions related to the first terminal device and the one or more second terminal devices.

17. The method according to claim 16, wherein the first terminal device is determined to enter RRC non-connected state when one or more of the following conditions are satisfied:
the result of the terminal device level inactivity monitoring indicates that the first terminal device and the one or more second terminal devices are inactive;
the result of the DRB level inactivity monitoring indicates that the DRB s related to the first terminal device and the one or more second terminal devices are inactive; and
the result of the PDU session level inactivity monitoring indicates that the PDU sessions related to the first terminal device and the one or more second terminal devices are inactive.

18. The method according to claim 16, wherein the first terminal device is determined not to enter RRC non-connected state when at least one of the one or more second terminal devices is determined to be kept in RRC connected state.

19-22. (canceled)

23. The method according to claim 12, wherein the base station comprises a distributed unit (DU) and a central unit (CU).

24. The method according to claim 23, further comprising:
when determining that the first terminal device should enter RRC non-connected state, sending, by the control plane to the DU, one or more third requests for bearer context release.

25-28. (canceled)

29. A method performed by a base station, comprising:
receiving, by a control plane of the base station from a user plane of the base station, information related to a traffic condition of a first terminal device that acts as a terminal device to network relay for one or more second terminal devices;
determining, by the control plane, whether the first terminal device should enter RRC non-connected state based on the received information;
when determining that the first terminal device should enter RRC non-connected state, determining, by the control plane, whether at least one of the one or more second terminal devices is in RRC connected state; and
when determining that at least one of the one or more second terminal devices is in RRC connected state, sending, by the control plane to the at least one second terminal device, a first request instructing to attempt path switching.

30. The method according to claim 29, wherein the first request indicates a cause for instructing to attempt path switching.

31-53. (canceled)

54. A method performed by a second terminal device, wherein the second terminal device in radio resource control (RRC) connected state connects to a network via a first terminal device acting as a terminal device to network relay, the method comprising:
receiving, from a control plane of a base station, a request instructing to attempt path switching; and
attempting path switching in response to the request.

55. The method according to claim 54, further comprising:
sending a measurement report to the control plane.

56-73. (canceled)
